(19) United States
(12) Patent Application Publication
(10) Pub. No.: US 2018/0275349 A1
(43) Pub. Date: Sep. 27, 2018

(54) IN-LINE FILTER HOLDER

(71) Applicant: Ocean Optics, Inc., Largo, FL (US)

(72) Inventors: Jonathan Drewes, Oviedo, FL (US); Bryan Auz, Orlando, FL (US)

(21) Appl. No.: 15/914,191

(22) Filed: Mar. 7, 2018

Related U.S. Application Data
(60) Provisional application No. 62/475,284, filed on Mar. 23, 2017.

(51) Int. Cl. G02B 6/32; G02B 6/38

(52) U.S. Cl. CPC G02B 6/32; G02B 6/3894

(57) ABSTRACT

An in-line filter holder that easily attaches between a light source and spectrometer in order to pre-filter and/or attenuate the spectrum that enables the easy insertion of one or more off the shelf filters is disclosed.

### CROSS-REFERENCE TO RELATED APPLICATION

The present application claims the benefit of previously filed Provisional Patent Application, Ser. No. 62/475,284, filed on Mar. 23, 2017.

### FIELD OF THE INVENTION

The device of this disclosure belongs to the field of optical devices. More specifically it is a new design configuration for an in-line filter holder.

### BACKGROUND OF THE INVENTION

In-line filter holders are commonly present between the source and spectrometer in order to pre-filter and/or attenuate the spectrum. This holder should be:
Low-cost;
Simple to manufacture, assemble;
Good throughput/efficiency from UV to NIR for mid and larger fiber core sizes;
Physically small, not taking much more space than needed to optically couple between two fibers;
Use just one type of lens at each end that would serve the need from the UV to NIR spectral ranges;
No need/ability for adjustment or calibration during manufacture or use; and,
Sturdy design and does not feel cheap.

Thus there is a need to have a very simple, low cost, easy-to-use fiber coupled ½″ filter holder. 12.7, 12.5, and ½″ diameter filters are ubiquitous and fast to obtain/purchase. The purpose of the disclosed design is to be able to install 1, 2, or 3 of such filters sequentially within one in-line filter holder.

### BRIEF SUMMARY OF THE INVENTION

The in-line filter holder of this disclosure has two sections held together by a threaded connector, holds standard filters separated by nylatron spacers, and uses a fused silica glass plano-convex spherical lens, which is readily available, in each section of the holder to collimate the light into and out of the fiber that would be attached at each end of the in-line filter holder.

### BRIEF DESCRIPTION OF THE DRAWINGS

For a fuller understanding of the nature and objects of the invention, reference should be made to the following detailed description, taken in connection with the accompanying drawings, in which:

FIG. 1 shows an optical layout view of the preferred embodiment of the in-line filter holder;

FIG. 2 shows a perspective exploded view of the preferred embodiment of the in-line filter holder; and,

FIG. 3 shows a perspective further exploded view of the preferred embodiment of the in-line filter holder.

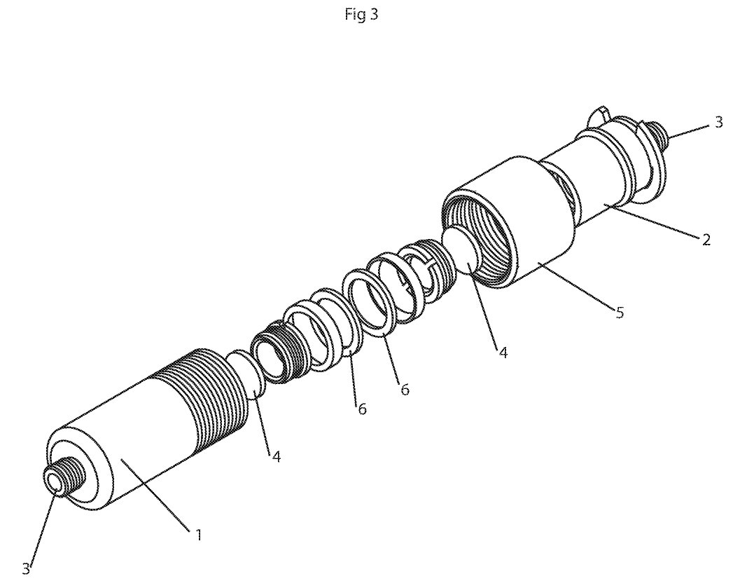

### DESCRIPTION OF THE PREFERRED EMBODIMENT

The optical design of the preferred embodiment is to use a fused silica glass plano-convex spherical lens which is readily available in each section of the holder to collimate the light into and out of the fiber that would be attached at each end of the in-line filter holder. This lens type is relatively low-cost and transmits well from UV to NIR. The symmetric design of the preferred embodiment allows the use of all fiber core diameters but with sub-optimal throughput for small fiber core sizes since adjustable lens-to-fiber alignment will not take place. This is an acceptable trade-off in order to meet the design objectives listed above.

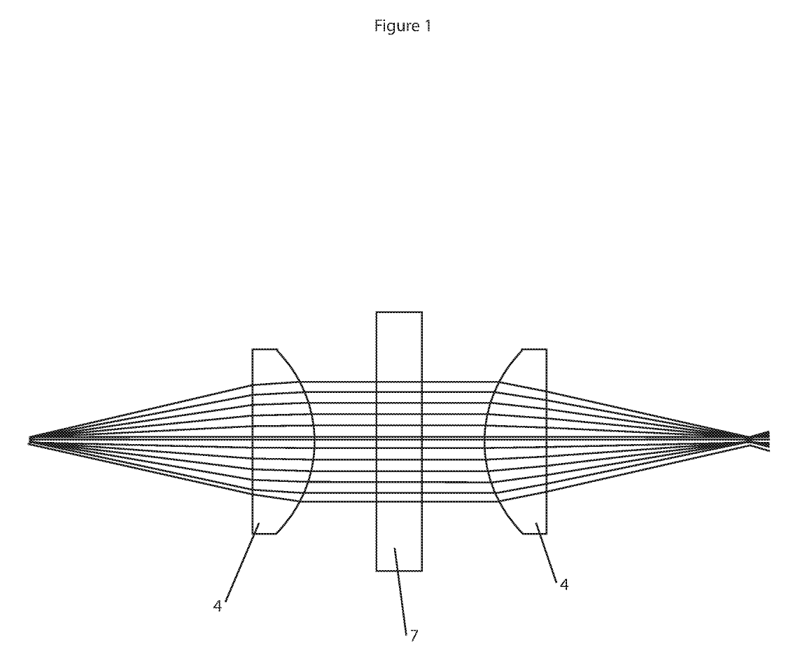

An optical ray-trace of the optical design of the preferred embodiment is shown in FIG. 1 wherein the distance between the two lenses (4) is allowed to increase somewhat in order to allow the various filters (7) to be placed between the lenses (4).

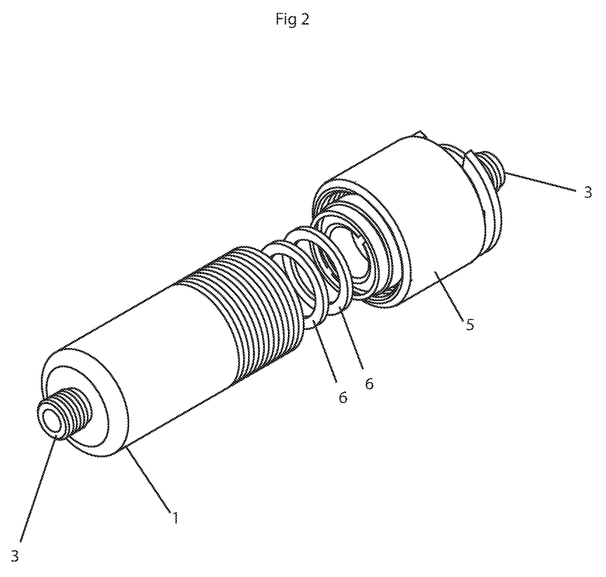

The mechanical design of the preferred embodiment shown in FIGS. 2 & 3 uses 6061-T6 aluminum and allows for the fibers to be directly attached to the end of each section of the filter holder via standard SMA connectors (3). Each of the two section pieces, section 1 (1) and section 2 (2), contains a collimating lens (4) and are joined together with a threaded tightening sleeve (5). Soft nylatron spacers (6) are used to allow up to three filters (7) to be placed inside the holder.

Since certain changes may be made in the above described in-line filter holder without departing from the scope of the invention herein involved, it is intended that all matter contained in the description thereof or shown in the accompanying figures shall be interpreted as illustrative and not in a limiting sense.

What is claimed is:

1. An in-line optical filter holding device that allows for optical fibers to be directly attached to each end of the in-line optical filter holder via standard SMA connectors comprising:
a first hollow cylindrical section and a second hollow cylindrical section;
said first hollow cylindrical section and said second hollow cylindrical section each having standard SMA connectors located at one end;
each of said first hollow cylindrical section and said second hollow cylindrical section containing a collimating lens;
said first hollow cylindrical section and said second hollow cylindrical section removably attachable at ends opposite said standard SMA connectors using a threaded tightening sleeve; and,
two or more nylatron spacers placed between each said collimating lens within said in-line optical filter holding device and used to allow one or more optical filters to be placed between said nylatron spacers when said first hollow cylindrical section and said second hollow cylindrical section are not attached and held inside said in-line optical filter holding device when said first hollow cylindrical section and said second hollow cylindrical section are attached.
